(19) United States
(12) Patent Application Publication
(10) Pub. No.: US 2022/0108047 A1
(43) Pub. Date: Apr. 7, 2022

(54) OPTIMIZATION DESIGN METHOD FOR NEW COMPOSITE STRUCTURE UNDER HIGH-DIMENSIONAL RANDOM FIELD CONDITION

(71) Applicant: ZHEJIANG UNIVERSITY, Hangzhou City (CN)

(72) Inventors: Jin CHENG, Hangzhou City (CN); Zhenyu LIU, Hangzhou City (CN); Minglong YANG, Hangzhou City (CN); Jianrong TAN, Hangzhou City (CN)

(21) Appl. No.: 17/553,828

(22) Filed: Dec. 17, 2021

Related U.S. Application Data
(63) Continuation of application No. PCT/CN2020/101178, filed on Jul. 10, 2020.

(30) Foreign Application Priority Data
Jun. 19, 2020 (CN) 202010569134.0

(51) Int. Cl. G06F 30/17; G06F 30/25; G06F 30/27; G06N 7/08

(52) U.S. Cl. CPC G06F 30/17; G06F 30/25; G06F 2111/10; G06N 7/08; G06F 30/27

(57) ABSTRACT

Provided is an optimization design method for new composite structure under a high-dimensional random field condition. The method includes the following steps: firstly, establishing a high-dimensional random field model considering spatially dependent uncertainty of material properties and loads considering the complexity of a preparation process and a service environment of a new composite structure, and then establishing an optimization design model of the new composite structure under the influence of the high-dimensional random field according to the high-rigidity and light-weight design requirement; secondly, combining a stochastic isogeometric analysis approach with a stochastic polynomial expansion enhanced Dagum kernel Kriging surrogate model, and efficiently and accurately calculating statistical characteristics of stochastic responses of the new composite structure under the influence of the high-dimensional random field; and finally, rapidly obtaining optimal design parameters of the new composite structure by utilizing a particle swarm optimization algorithm. (FIG. 1)

### CROSS-REFERENCE TO RELATED APPLICATIONS

The present application is a continuation of International Application No. PCT/CN2020/101178, filed on Jul. 10, 2020, which claims priority to Chinese Application No. 202010569134.0, filed on Jun. 19, 2020, the contents of both of which are incorporated herein by reference in their entireties.

### TECHNICAL FIELD

The present invention relates to the field of engineering, and in particular relates to an optimization design method for a new composite structure under a high-dimensional random field condition.

### BACKGROUND

Composite materials have the advantages of light weight, high rigidity, high strength and the like, and application of the composite materials in engineering has increasingly become common in recent years. For example, structures such as a cutter head of a hard rock tunnel boring machine with the high strength and high rigidity requirement are very suitable for being made of the composite materials. Because the preparation process of the composite material is complex, material properties of the composite material have apparent randomness. And the service environment of the new composite structure is often very complex and severe. Taking the cutter head of a hard rock tunnel boring machine as an example, in the service process, the cutter head frequently collides with irregular hard objects such as rock fragments and gravels, and the magnitude and direction of loads exerted on the cutter head are naturally random. Due to these uncertainties, the displacement and stress of the new composite structure are inevitably random. Therefore, in response analysis and optimization design of the new composite structure, random uncertainties of the material and the load needs to be fully considered.

Stochastic response analysis of a structure is mainly implemented by an experimental method and a simulation method. The former needs a large number of experiments to simulate uncertainties such as random loads, and the accuracy of experimental results is difficult to guarantee because sensors cannot be arranged on the whole surface of the structure to accurately acquire the stochastic response information of the structure; and when structural design parameters are changed, a corresponding test piece needs to be manufactured for experiment, so that the cost is high. The latter establishes a simulation model of the structure by means of three-dimensional modeling and numerical calculation software, to analyze and calculate the stochastic structural responses, so that structural responses under the random field loads can be obtained efficiently, accurately and economically, and thus the latter is more suitable for the optimization design of the uncertain structures.

In existing finite element analysis, the transformation between a CAD model and a CAE model will lead to the loss of geometric information of the CAD model due to the discretization operation of grid units, and the grid units can only approximately represent complex geometric shapes (such as a sharp corner and a complex curved surface), so that the CAE model for analysis has geometric discrete errors.

The material properties of the composite structure are influenced by multiple factors such as the substrate material property, filler material property and filling mode, the number of random variables is large, and the problem of high-dimensional randomness is to be solved. When the problem of high-dimensional randomness is solved by existing embedded stochastic analysis, an explicit expression of a stochastic response is very complex, the dimension of a stochastic rigidity matrix is very high, and the calculation efficiency is very low.

### SUMMARY

To overcome the limitations in the prior art, the present invention provides a method for the optimization design of a new composite structure under a high-dimensional random field condition. Compared with traditional finite element analysis, a geometric analysis technology directly uses a CAD model as a CAE model for analysis, and geometric discrete errors generated when a three-dimensional CAD model is transformed into a CAE analysis model are eliminated in principle. In addition, the method provided by the present invention adopts non-embedded stochastic analysis, an surrogate model is applied to calculate a stochastic response of a new composite structure, an explicit expression of the stochastic response does not need to be provided, and the surrogate model is trained through the results obtained by a few times of isogeometric analysis, so that the stochastic responses of large-scale samples are obtained, the problem that the dimension of a matrix is too high due to high-dimensional random variables is avoided, the computational complexity of stochastic analysis is greatly reduced, and the calculation efficiency of the non-embedded stochastic analysis is much higher than that of the embedded stochastic analysis.

The method includes the following steps: firstly, establishing a high-dimensional random field model of material properties and loads according to the manufacturing condition and the service environment of a composite structure, on such basis, establishing an optimization design model according to the high-rigidity and light-weight design requirement of the structure, and solving the model by adopting a particle swarm optimization algorithm. In the solving process, the stochastic structural responses under random fields of material properties and loads are calculated by adopting a stochastic isogeometric analysis approach, and the optimal combination of structural design parameters is achieved, so that the high-rigidity and light-weight design of the new composite structure under high-dimensional random field environment is realized. According to the analysis and optimization design method for a new composite structure provided by the present invention, the high-dimensional randomness of the material properties and loads is comprehensively considered, the stochastic response of the new composite structure is calculated by combining the stochastic isogeometric analysis approach with a stochastic polynomial expansion enhanced Dagum kernel Kriging surrogate model, and thus the random displacement and stress of the new composite structure can be efficiently and accurately obtained.

In order to achieve the above purpose, the present invention adopts the technical scheme as follows: an optimization design method for a new composite structure under a high-dimensional random field condition, wherein the method includes the following steps:

1) parameterizing a new composite structure, and determining structural design parameters and value ranges thereof;

2) adopting random fields to describe material properties and loads of the new composite structure considering spatially dependent uncertainties:

E(x, θ)=H_{L}^{E}(x, θ)

v(x, θ)=H_{L}^{v}(x, θ)

q(x, θ)=H_{L}^{q}(x, θ)

α(x, θ)=H_{G}^{α}(x, θ)

β(x, θ)=H_{G}^{β}(x, θ)

where x is a point coordinate on a surface in the new composite structure, θ is a sample set of the random fields, E(x, θ), v(x, θ), q(x, θ), α(x, θ), β(x, θ) are the Young's modulus, Poisson ratio, load magnitude, load direction angle α (an included angle between the load and the z axis in a space rectangular coordinate system) and load direction angle β (an included angle between the load and the x axis in the space rectangular coordinate system) of the new composite structure, respectively, H_{L}^{E}(x, θ), H_{L}^{v}(x, θ), H_{L}^{q}(x, θ) represent lognormal random fields of the Young's modulus, Poisson ratio and load of the new composite structure with the spatially dependent uncertainty, respectively, H_{G}^{α}(x, θ), H_{G}^{β}(x, θ) represent Gaussian random fields of the load direction angle α and the load direction angle β of the new composite structure with the spatially dependent uncertainty, respectively;

3) according to a high-rigidity and light-weight design requirement of the new composite structure, giving expressions of an objective function and constraint functions for structural optimization design, and establishing a high-rigidity and light-weight design model of the new composite structure:

$${min}_{k} f ( k )$$

$$s . t . {μ}_{S ( k , r )} + j {σ}_{S ( k , r )} \leq [ S ] ;$$

$${μ}_{U ( k , r )} + j {σ}_{U ( k , r )} \leq [ U ] ;$$

$${k}_{min} \leq k \leq {k}_{max}$$

where k is a design vector of the new composite structure and comprises several structural design parameters; r={E(x, θ), v(x, θ), q(x, θ), α(x, θ), β(x, θ)} is a random field vector; ƒ(k) is an objective function representing the weight of the new composite structure; μ_{S(k,r)} is a mean value of random structural stresses; σ_{S(k,r)} is a standard deviation of the random structural stresses; [S] is an allowable stress; μ_{U(k,r)} is a mean value of random structural displacements; σ_{U(k,r)} is a standard deviation of the random structural displacements; [U] is an allowable displacement; j is a boundary parameter, representing a strictness degree of the requirement on structural response values; kₘᵢₙ and kₘₐₓ are a lower limit and an upper limit of the value of the structural design vector, respectively;

4) calculating an optimal solution of the high-rigidity and light-weight design model of the new composite structure by adopting a particle swarm optimization algorithm, which specifically comprises the following sub-steps:

4.1) initializing a particle swarm, and randomly initializing each particle;

4.2) by combining a stochastic isogeometric analysis approach with a stochastic polynomial expansion enhanced Dagum kernel Kriging surrogate model, calculating the statistical characteristics of the stochastic responses of the new composite structure corresponding to each particle, which specifically comprises the following steps:

4.2.1) establishing a CAD model of the new composite structure based on NURBS or T-spline functions according to structural design parameter values of a current particle;

4.2.2) implementing Karhunen-Loève expansion to obtain discrete expressions of the random fields of the structural material properties and loads, and discretizing each random field into a sum of functions of M standard Gaussian random variables;

4.2.3) carrying out sampling design on all the Gaussian random variables, determining a number of training samples, and obtaining small-scale samples of the random fields of the structural material properties and loads;

4.2.4) for each sample, obtaining material properties and a load value, setting boundary conditions, and calculating its structural response by an isogeometric analysis approach;

4.2.5) repeating sub-step 4.2.4 until all the training samples are traversed;

4.2.6) according to the obtained structural response values of all the training samples, training the stochastic polynomial expansion enhanced Dagum kernel Kriging surrogate model;

4.2.7) carrying out large-scale sampling on the random fields of the structural material properties and loads, and obtaining the structural response of each sample through the trained stochastic polynomial expansion enhanced Dagum kernel Kriging surrogate model; and

4.2.8) calculating a mean value and a standard deviation of a random displacement and a random stress of the new composite structure corresponding to the current particle according to the structural responses of the large-scale samples obtained through the stochastic polynomial expansion enhanced Dagum kernel Kriging surrogate model;

4.3) calculating a fitness value of each particle according to the weight of corresponding structure, judging whether the statistical characteristics of the structural random displacement and random stress corresponding to each particle meet constraints on stress and displacement, and if no, adding a penalty function to the fitness of the particle to produce an extreme value of the fitness;

4.4) updating an optimal value according to the fitness, and updating a speed and a position of the particle; and

4.5) judging whether termination conditions are met, if no, repeating steps 4.2 to 4.4, and if yes, outputting the optimal solution; and

5) determining optimal structural design parameter values according to the optimal solution of the high-rigidity and light-weight design model of the new composite structure obtained in step 4 to obtain an optimized new composite structure.

Furthermore, in step 4.2.6, training the stochastic polynomial expansion enhanced Dagum kernel Kriging surrogate model includes the following steps:

1) standardizing input data to obtain training data with a mean value of 0 and a standard deviation of 1;

2) expanding the training data by using a random chaos polynomial, and obtaining parameters and weights of the random chaos polynomial;

3) training the Kriging model:

3.1) taking the obtained random chaos polynomial as a regression function for the Kriging model;

3.2) taking a Dagum function as a correlation function for the Kriging model, the

Dagum function being as follows:

$$R ( p , {p}^{′} ; ξ ) = \frac{2 exp ( - {a ( ξ \vert p - {p}^{′} \vert )}^{2} )}{1 + exp ( - {b ( ξ \vert p - {p}^{′} \vert )}^{2} )} , a , b > 0$$

where R(p, p′; ξ) represents the correlation function of the Kriging model, p, p′ are two different training data points, and ξ, a, b are hyper-parameters to be obtained by training the Kriging model;

3.3) applying a cross-validation error as a convergence criterion for the Kriging model;

3.4) applying a covariance matrix adaptive evolution strategy to find the appropriate hyper-parameters to meet the convergence criterion; and

3.5) according to the obtained random chaos polynomial and the optimal hyper-parameters, obtaining the trained stochastic polynomial expansion enhanced Dagum kernel Kriging surrogate model.

The method has the beneficial effects that the high-dimensional randomness of the material properties and the loads of the new composite structure are comprehensively considered, and the random fields of the material properties and the loads are established for analysis, so that the response analysis of the new composite structure is more comprehensive and better conforms to the practical situation. In the optimization design of the new composite structure, an advanced technology of stochastic isogeometric analysis is used for analyzing the structural responses of the new composite structure under the influence of the material properties and loads with high-dimensional randomness, and approximation errors generated when the three-dimensional CAD model is transformed into the CAE analysis model are eliminated in principle. Meanwhile, the stochastic responses of the new composite structure are calculated by utilizing the stochastic polynomial expansion enhanced Dagum kernel Kriging surrogate model, which is efficient in calculation and easy to program. The surrogate model is combined with the isogeometric analysis approach, so that the stochastic response of the new composite structure under the influence of the material properties and loads with high-dimensional randomness can be quickly and accurately calculated, and the efficient solution of the optimization design model of the new composite structure is realized.

### BRIEF DESCRIPTION OF DRAWINGS

FIG. 1 is an optimization design flow chart of a new composite structure under a high-dimensional random field condition.

FIG. 2 is a schematic diagram of structural design parameters of a cutter head of a hard rock tunnel boring machine.

FIG. 3 is a CAD model of the cutter head of a hard rock tunnel boring machine.

### DESCRIPTION OF EMBODIMENTS

The present invention is further described below with reference to the accompanying drawings and specific embodiments.

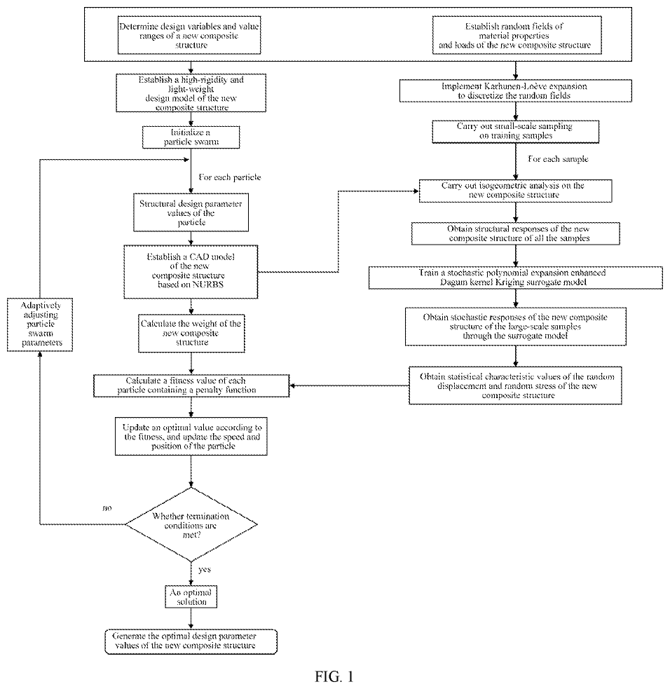

Taking an outer cutter head of a certain type of hard rock tunnel boring machine as an analysis object, a high-rigidity and light-weight design flow of the outer cutter head is shown in FIG. 1. A high-rigidity and light-weight design method for the outer cutter head of the hard rock tunnel boring machine is specifically as follows:

1, an outer cutter head structure is parameterized, and design parameters and value ranges are determined according to the outer cutter head structure.

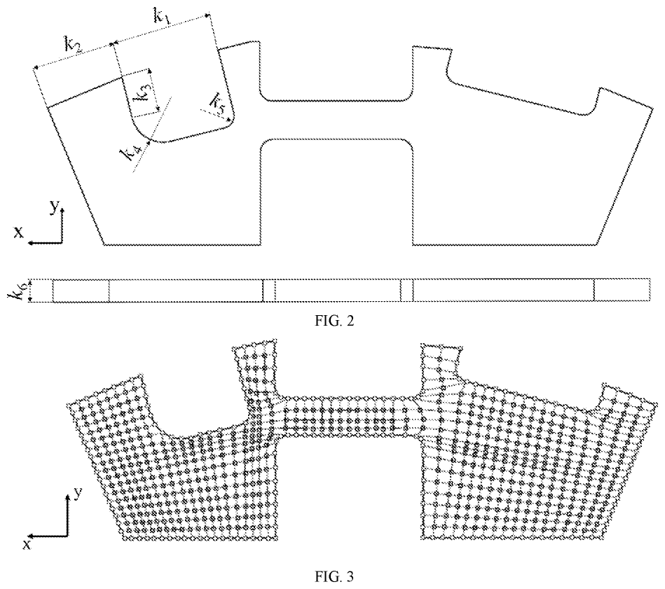

The structure of the outer cutter head of the hard rock tunnel boring machine is shown in FIG. 2, and the structural design parameters of the outer cutter head are k={k₁, k₂, k₃, k₄, k₅, k₆}, wherein k₁, k₂, k₃ are length, k₄, k₅ are fillet radius and k₆ is thickness of the outer cutter head. And other structural design parameters cannot be changed due to the binding with a cutter size.

2, the outer cutter head is made of a ceramic-metal composite material, and the material properties and the load exerted on the outer cutter head in a service process have spatially dependent uncertainties and are described by random fields:

E(x, θ)=H_{L}^{E}(x, θ)

v(x, θ)=H_{L}^{v}(x, θ)

q(x, θ)=H_{L}^{q}(x, θ)

α(x, θ)=H_{G}^{α}(x, θ)

β(x, θ)=H_{G}^{β}(x, θ)

wherein x is a point coordinate on a surface in the outer cutter head, x is a sample set of the random fields, E(x, θ), v(x, θ), q(x, θ), α(x, θ), β(x, θ) are the Young's modulus, Poisson ratio, load magnitude, load direction angle α (an included angle between the load and the z axis in a space rectangular coordinate system) and load direction angle β (an included angle between the load and the x axis in the space rectangular coordinate system) of the outer cutter head, respectively, H_{L}^{E}(x, θ), H_{L}^{v}(x, θ), H_{L}^{q}(x, θ) represent lognormal random fields of the Young's modulus, Poisson ratio and load of the outer cutter head with the spatially dependent uncertainty, H_{G}^{α}(x, θ), H_{G}^{β}(x,θ) represent Gaussian random fields of the load direction angle α and the load direction angle β of the outer cutter head with the spatially dependent uncertainty.

The mean value of the random fields of Young's modulus of the outer cutter head is μ_{E}=2.06×10¹¹ Pa, and the standard deviation is σ_{E}=2.06×10¹⁰ Pa. The mean value of the random fields of Poisson ratio is μᵥ=0.3, and the standard deviation is σᵥ=0.03. The mean value of the random fields of the load is μ_{q}=2.6×10⁷ N/m², and the standard deviation is σ_{q}=2.964×10⁶ N/m². The mean value of the random fields of the load direction angle α is μ_{α}=0, and the standard deviation is σ_{α}=0.125. The mean value of the random fields of the load direction angle β is μ_{β}=π/4, and the standard deviation is σ_{β}=0.133.

Covariance functions of the random fields of the Young's modulus, Poisson ratio, load, load direction angle α, and the load direction angle β of the outer cutter head are all exponential:

$${C}_{xx} ( x , {x}^{′} ) = {σ}^{2} exp ( - \frac{\vert {x}_{1} - {x}_{2} \vert}{2} - \frac{\vert {y}_{1} - {y}_{2} \vert}{2} ) x , {x}^{′} ∈ D ⋐ {•}^{2}$$

3, according to the high-rigidity and light-weight design requirement of the outer cutter head, expressions of an objective function and constraint functions are given for structural optimization design of the outer cutter head, and a high-rigidity and light-weight design model of the outer cutter head is established:

$${min}_{k} f ( k )$$

$$s . t . {μ}_{S ( k , r )} + j {σ}_{S ( k , r )} \leq [ S ] ;$$

$${μ}_{U ( k , r )} + j {σ}_{U ( k , r )} \leq [ U ] ;$$

$${k}_{min} \leq k \leq {k}_{max}$$

wherein k is a design vector of the new composite structure and includes several structural design parameters; r={E(x, θ), v(x, θ), q(x, θ), α(x, θ), β(x, θ)} is random field vector; ƒ(k) is an objective function representing the weight of the new composite structure; μ_{S(k, r)} is the mean value of random structural stresses; σ_{S(k,r)} is the standard deviation of the random structural stresses; [S] is the allowable stress obtained by dividing the yield strength of composite outer cutter head with average material properties by a safety factor; μ_{U(k,r)} is the mean value of random structural displacements; σ_{U(k,r)} is the standard deviation of the random structural displacements; [U] is the allowable displacement, the value of which is 3% of the diameter of the outer cutter head; j is a boundary parameter, and j=6 which is determined based on the principle of six sigma in the present embodiment; kₘᵢₙ and kₘₐₓ are a lower limit and an upper limit of the value of the structural design vector.

4, a high-rigidity and light-weight design model of the outer cutter head is solved by adopting a particle swarm optimization algorithm, the inertia weight being set to be 0.85, the learning factor being set to be 0.5, the variable dimension being set to be 5, the population size being set to be 30, and the maximum iteration number being set to be 120.

4.1, a particle swarm is initialized, and each particle is randomly initialized.

4.2, a stochastic isogeometric analysis approach is combined with a stochastic polynomial expansion enhanced Dagum kernel Kriging surrogate model, and statistical characteristics of stochastic responses of the outer cutter head corresponding to each particle are calculated, which specifically include the following steps:

4.2.1, an outer cutter head CAD model is established based on NURBS or T-spline functions according to structural design parameter values of the current particle, as shown in FIG. 3.

4.2.2, Karhunen-Loève expansion is applied to obtain the discrete expressions of random fields of the structural material properties and load, and each random field is discretized into the sum of functions of 8 standard Gaussian random variables, that is, all the random fields are discretized by a total of 40 standard Gaussian random variables.

4.2.3, Latin hypercube sampling is carried out on all the Gaussian random variables with the sampling number of 200, the results of which are utilized as the input of training samples, and the isogeometric analysis method is applied to calculate the structural responses of the outer cutter head, the results of which are utilized as the output of the training samples.

4.2.3.1, random filed data are sampled to obtain the Young's modulus, Poisson ratio, load magnitude, load direction angle a and load direction angle β of each sample point of the outer cutter head.

4.2.3.2, for each sample, the structural responses of the outer cutter head are calculated by the isogeometric analysis approach.

4.2.3.2.1, the CAD model based on the T-spline functions of the outer cutter head is imported into MATLAB software, to set the Young's modulus, Poisson ratio, load magnitude, load direction and constraints.

4.2.3.2.2, the structural responses of the outer cutter head are calculated, the structural responses including the displacement and the stress of the outer cutter head.

4.2.3.3, step 4.2.3.2 is repeated until all the training samples are traversed, and the stochastic responses of the outer cutter head of all the training samples are obtained.

4.2.4, according to the obtained structural response values of the outer cutter head of all the training samples, the stochastic polynomial expansion enhanced Dagum kernel Kriging surrogate model is trained.

4.2.4.1, input data is standardized to obtain training data with the mean value of 0 and the standard deviation of 1, and the dimension of the training data is R^{200×50}.

4.2.4.2, the training data is expanded by using a random chaos polynomial, as shown in formula below, and the parameters and the weight of the random chaos polynomial are obtained.

$$C ( p ) = {\sum }_{j = 0}^{T} {u}_{j} ( p ) {Ψ}_{j} ( η )$$

wherein p is a data point, C (p) is the random chaos polynomial, and T is a term number of polynomial; uⱼ(p) are the expansion weights, Ψⱼ(η) are a series of orthogonal polynomials containing different parameters with respect to the random variables η.

4.2.4.3, the Kriging model is trained.

4.2.4.3.1, the obtained random chaos polynomial is taken as a regression function of the Kriging model.

4.2.4.3.2, a Dagum function is taken as a correlation function of the Kriging model, the Dagum function being as follows.

$$R ( p , {p}^{′} ; ξ ) = \frac{2 exp ( - {a ( ξ \vert p - {p}^{′} \vert )}^{2} )}{1 + exp ( - {b ( ξ \vert p - {p}^{′} \vert )}^{2} )} , a , b > 0$$

wherein R(p, p′; ξ) represents a correlation function of the Kriging model, p, p′ are two different training data points, and ξ, a, b are hyper-parameters to be obtained by training the Kriging model.

4.2.4.3.3, the cross-validation error is applied as a convergence criterion for the Kriging model.

4.2.4.3.4, a covariance matrix adaptive evolution strategy is applied to find the appropriate hyper-parameters to minimize the cross-validation error.

4.2.4.4, the trained stochastic polynomial expansion enhanced Dagum kernel Kriging surrogate model is obtained according to the obtained random chaos polynomial and the optimal hyper-parameters, as shown in the formula below.

Ŷ(p)=F(p)+Z(p, ξ)

wherein Ŷ(p) is the output of the Kriging model, F(p) is a regression function of the Kriging model, and Z(p, ξ) is a Gaussian process determined by the correlation function R(p, p′; ξ).

4.2.5, large-scale sampling is carried out on the random fields of the outer cutter head, the sampling number being one million, and the stochastic response of the outer cutter head of each sample is obtained through the trained stochastic polynomial expansion enhanced Dagum kernel Kriging surrogate model.

4.2.6, the statistical characteristics of random displacements and random stresses are calculated based on the obtained stochastic responses of the outer cutter head of the large-scale samples, the statistical characteristics including the mean value and the standard deviation.

4.3, a fitness value of each particle is calculated according to the weight of the outer cutter head. It is judged that whether the statistical characteristics of the stochastic response of the outer cutter head corresponding to each particle meet constraints on stress and displacement, and if no, a penalty function is added to the fitness of the particle to produce an extreme value of the fitness of the particle.

4.4, an optimal value is updated according to the fitness, and the speed and position of the particle are updated.

4.5, it is judged that whether termination conditions are met, if not, steps 4.2 to 4.4 are repeated, and if yes, an optimal solution is output.

4.6, the optimized structure of the outer cutter head is obtained according to the optimal structural design parameters.

The structural design parameter values of the outer cutter head before and after optimization are shown in Table 1. Comparing the optimization result with the initial scheme, the weight of the outer cutter head before optimization is 728.7 kg, and the weight of the outer cutter head after optimization is 690.0 kg. The statistical characteristics of random displacement and random stress of the optimized outer cutter head considering the randomness of the material properties and load meet the constraints given by allowable displacement and allowable stress, while the weight is reduced by 5.3%, and thus the high-rigidity and light-weight design of the outer cutter head is achieved.

TABLE 1
Comparison of initial values and optimization results
of design parameters of outer cutter head

| design parameter | k₁ | k₂ | k₃ | k₄ | k₅ | k₆ |
|---|---|---|---|---|---|---|
| initial value (mm) | 400 | 320 | 170 | 127 | 50 | 90 |
| optimization result (mm) | 448.4 | 253.1 | 239.2 | 108.6 | 59.5 | 88.9 |

The embodiments described above are merely exemplary of the present invention, and although the preferred embodiments and the accompanying drawings of the present invention have been disclosed for purposes of illustration, those of ordinary skill in the art should be appreciated that various substitutions, variations, and modifications are possible without departing from the spirit and scope of the present invention and the appended claims. Therefore, the present invention should not be limited to the content disclosed in the preferred embodiments and the accompanying drawings.

What is claimed is:

1. An optimization design method for new composite structure under a high-dimensional random field condition, wherein the method comprises the following steps:
1) parameterizing a new composite structure, and determining structural design parameters and value ranges thereof;
2) adopting random fields to describe material properties and loads of the new composite structure considering spatially dependent uncertainty:
E(x, θ)=H_{L}^{E}(x, θ)
v(x, θ)=H_{L}^{v}(x, θ)
q(x, θ)=H_{L}^{q}(x, θ)
α(x, θ)=H_{G}^{α}(x, θ)
β(x, θ)=H_{G}^{β}(x, θ)
where x is a point coordinate on a surface in the new composite structure, θ is a sample set of the random fields, E(x, θ), v(x, θ), q(x, θ), α(x, θ), β(x, θ) are the Young's modulus, Poisson ratio, load magnitude, load direction angle α (an included angle between the load and the z axis in a space rectangular coordinate system) and load direction angle β (an included angle between the load and the x axis in the space rectangular coordinate system) of the new composite structure, respectively, H_{L}^{E}(x, θ), H_{L}^{v}(x, θ), H_{L}^{q}(x, θ) represent lognormal random fields of the Young's modulus, Poisson ratio and load of the new composite structure with the spatially dependent uncertainty, respectively, H_{G}^{α}(x, θ), H_{G}^{β}(x, θ) represent Gaussian random fields of the load direction angle α and the load direction angle β of the new composite structure with the spatially dependent uncertainty, respectively;
3) according to a high-rigidity and light-weight design requirement of the new composite structure, giving expressions of an objective function and constraint functions for structural optimization design, and establishing a high-rigidity and light-weight design model of the new composite structure:
$${min}_{k} f ( k )$$
$$s . t . {μ}_{S ( k , r )} + j {σ}_{S ( k , r )} \leq [ S ] ;$$
$${μ}_{U ( k , r )} + j {σ}_{U ( k , r )} \leq [ U ] ;$$
$${k}_{min} \leq k \leq {k}_{max}$$
where k is a design vector of the new composite structure and comprises several structural design parameters; r={E(x, θ), v(x, θ), q(x, θ), α(x, θ), β(x, θ)} is a random field vector; ƒ(k) is an objective function representing the weight of the new composite structure; μ_{S(k,r)} is a mean value of random structural stresses; σ_{S(k,r)} is a standard deviation of the random structural stresses; [S] is an allowable stress; μ_{U(k,r)} is a mean value of a random structural displacement; σ_{U(k,r)} is a standard deviation of the random structural displacement; [U] is an allowable displacement; j is a boundary parameter representing a strictness degree of the requirement on structural response values; kₘᵢₙ and kₘₐₓ are a lower limit and an upper limit of the value of the structural design vector, respectively;
4) calculating an optimal solution of the high-rigidity and light-weight design model of the new composite structure by adopting a particle swarm optimization algorithm, which specifically comprises the following sub-steps:
4.1) initializing a particle swarm, and randomly initializing each particle;
4.2) calculating, by combining a stochastic isogeometric analysis approach with a stochastic polynomial expansion enhanced Dagum kernel Kriging surrogate model, statistical characteristics of the stochastic response of the new composite structure corresponding to each particle, which specifically comprises the following steps:
4.2.1) establishing a CAD model of the new composite structure based on NURBS or T-spline functions according to structural design parameter values of a current particle;
4.2.2) implementing Karhunen-Loève expansion to obtain discrete expressions of the random fields of the structural material properties and loads, and discretizing each random field into a sum of functions of M standard Gaussian random variables;
4.2.3) carrying out sampling design on all the Gaussian random variables, determining a number of training samples, and obtaining small-scale samples of the random fields of the structural material properties and loads;
4.2.4) obtaining, for each sample, material properties and a load value, setting boundary conditions, and calculating a structural response thereof by an isogeometric analysis approach;
4.2.5) repeating sub-step 4.2.4 until all the training samples are traversed;
4.2.6) training the stochastic polynomial expansion enhanced Dagum kernel Kriging surrogate model, according to the obtained structural response values of all the training samples;
4.2.7) carrying out large-scale sampling on the random fields of the structural material properties and loads, and obtaining the structural response of each sample through the trained stochastic polynomial expansion enhanced Dagum kernel Kriging surrogate model; and
4.2.8) calculating a mean value and a standard deviation of a random displacement and a random stress of the new composite structure corresponding to the current particle according to the structural responses of the large-scale samples obtained through the stochastic polynomial expansion enhanced Dagum kernel Kriging surrogate model;
4.3) calculating a fitness value of each particle according to the weight of corresponding structure, judging whether the statistical characteristics of the structural random displacement and random stress corresponding to each particle meet constraints on stress and displacement, and if the statistical characteristics of the structural random displacement and random stress corresponding to each particle do not meet stress and displacement constraints, adding a penalty function to the fitness of the particle to produce an extreme value of the fitness;
4.4) updating an optimal value according to the fitness, and updating a speed and a position of the particle; and
4.5) judging whether termination conditions are met, if termination conditions are not met, repeating steps 4.2 to 4.4, and if termination conditions are met, outputting the optimal solution; and
5) determining optimal structural design parameter values according to the optimal solution of the high-rigidity and light-weight design model of the new composite structure obtained in step 4 to obtain an optimized new composite structure.

2. The method for optimization design of new composite structure under the high-dimensional random field condition according to claim 1, wherein in step 4.2.6, training the stochastic polynomial expansion enhanced Dagum kernel Kriging surrogate model comprises the following steps:
1) standardizing input data to obtain training data with a mean value of 0 and a standard deviation of 1;
2) expanding the training data by using a random chaos polynomial, and obtaining parameters and weights of the random chaos polynomial;
3) training the Kriging model:
3.1) taking the obtained random chaos polynomial as a regression function for the Kriging model;
3.2) taking a Dagum function as a correlation function for the Kriging model, the Dagum function being as follows:
$$R ( p , {p}^{′} ; ξ ) = \frac{2 exp ( - {a ( ξ \vert p - {p}^{′} \vert )}^{2} )}{1 + exp ( - {b ( ξ \vert p - p \vert )}^{2} )} , a , b > 0$$
where R(p, p′; ξ) represents the correlation function of the Kriging model, p, p′ are two different training data points, and ξ, a, b are hyper-parameters to be obtained by training the Kriging model;
3.3) applying a cross-validation error as a convergence criterion for the Kriging model;
3.4) applying a covariance matrix adaptive evolution strategy to find appropriate hyper-parameters to meet the convergence criterion; and
3.5) obtaining the trained stochastic polynomial expansion enhanced Dagum kernel Kriging surrogate model, according to the obtained random chaos polynomial and the optimal hyper-parameters.
